(19) United States
(12) Patent Application Publication
(10) Pub. No.: US 2019/0308442 A1
(43) Pub. Date: Oct. 10, 2019

(54) MECHANICAL PENCIL

(71) Applicant: KOTOBUKI & CO., LTD., Kawagoe-shi (JP)

(72) Inventors: Yoshio NOGUCHI, Kawagoe-shi (JP); Tadao ODAKA, Kawagoe-shi (JP); Yuichi KAMISAWA, Kawagoe-shi (JP)

(21) Appl. No.: 16/433,945

(22) Filed: Jun. 6, 2019

Related U.S. Application Data
(63) Continuation of application No. PCT/JP2017/045013, filed on Dec. 15, 2017.

(30) Foreign Application Priority Data
Dec. 15, 2016 (JP) 2016-243070

(51) Int. Cl. B43K 21/22; B43K 21/00; B43K 21/16

(52) U.S. Cl. CPC B43K 21/22; B43K 21/16; B43K 21/006

(57) ABSTRACT

A mechanical pencil according to an embodiment includes a barrel; and a chucking/feed-out mechanism chucking and feeding out a writing lead for a mechanical pencil, the chucking/feed-out mechanism configured to include a chuck, a chuck ring, and a chuck spring and being substantially housed in the barrel, wherein the barrel has a first level difference on an inner circumferential surface thereof, the chucking/feed-out mechanism has a second level difference opposing the first level difference, and when a prescribed load in an axial direction is applied to the writing lead for a mechanical pencil, the first level difference and the second level difference engage with each other in the axial direction to reduce an output of the chuck spring with respect to the chucking/feed-out mechanism and relax the chuck on the writing lead for a mechanical pencil by the chuck and the chuck ring.

### CROSS-REFERENCE TO RELATED APPLICATION

This application is based upon and claims the benefit of priority under 35 USC 119 of PCT Application No. PCT/JP2017/045013 filed on Dec. 15, 2017 (Earlier Application is Japanese Patent Application No. JP2016-243070.), the entire disclosure of which, including the description, claims, drawings, and abstract, is incorporated herein by reference in its entirety.

### TECHNICAL FIELD

The plurality of embodiments of this disclosure relate to a mechanical pencil capable of chucking a writing lead for a mechanical pencil with a chuck and feeding out the writing lead for a mechanical pencil by a push operation.

### BACKGROUND ART

Conventionally, a mechanical pencil is known which includes a slider to which a writing lead guide is fixed, the writing lead guide including a sliding piece that slides on an inner circumferential surface of a tip implement and further including a projection on an outer circumferential part of a rear end of the sliding piece, wherein grooves with which the projection engages are formed on the inner circumferential surface of the tip implement at positions where the lead guide protrudes and retracts from a hole at a tip of the tip implement (for example, refer to Japanese Utility Model Application Laid-open No. H05-12184 (for example, paragraphs 0008 and 0009, and FIG. 1)). According to the mechanical pencil disclosed in Japanese Utility Model Application Laid-open No. H05-12184, the writing lead guide can be fixed at a protruding position when writing with the mechanical pencil and can be kept in a retracted state when not using the mechanical pencil.

With a conventional mechanical pencil, when a prescribed load in an axial direction is applied to the writing lead guide, the writing lead guide recedes to prevent any damage to the writing lead guide. However, conventionally, there were cases where, when a prescribed load in an axial direction is applied to a writing lead for a mechanical pencil, the writing lead for a mechanical pencil chucked by a chuck breaks or the writing lead for a mechanical pencil chucked by the chuck recedes while having an outer circumferential surface thereof scraped. In such cases, since a chucking force by which the writing lead for a mechanical pencil with the scraped outer circumferential surface is once again chucked by the chuck declines, writing becomes difficult.

### SUMMARY

This disclosure provides a mechanical pencil capable of relaxing a chuck on a writing lead for a mechanical pencil by a chuck and causing the writing lead for a mechanical pencil to recede when a prescribed load in an axial direction is applied to the writing lead for a mechanical pencil.

In an aspect of the present invention, a mechanical pencil includes a barrel; and a chucking/feed-out mechanism chucking and feeding out a writing lead for a mechanical pencil, the chucking/feed-out mechanism configured to include a chuck, a chuck ring, and a chuck spring and being substantially housed in the barrel, wherein the barrel has a first level difference on an inner circumferential surface thereof, the chucking/feed-out mechanism has a second level difference opposing the first level difference, and when a prescribed load in an axial direction is applied to the writing lead for a mechanical pencil, the first level difference and the second level difference engage with each other in the axial direction to reduce an output of the chuck spring with respect to the chucking/feed-out mechanism and relax the chuck on the writing lead for a mechanical pencil by the chuck and the chuck ring.

In an aspect of the present invention, a mechanical pencil capable of relaxing a chuck on a writing lead for a mechanical pencil by a chuck and causing the writing lead for a mechanical pencil to recede when a prescribed load in an axial direction is applied to the writing lead for a mechanical pencil can be provided.

### BRIEF DESCRIPTION OF DRAWINGS

FIG. 1A is a partially-enlarged longitudinal sectional view illustrating, enlarged, a front-side portion and a rear-side portion while omitting an intermediate portion of a mechanical pencil according to a first embodiment;

FIG. 1B is an enlarged sectional view illustrating, enlarged and from the rear, the mechanical pencil according to the first embodiment cut away along a cutting plane A-A illustrated in FIG. 1A;

FIG. 2 is a partially-enlarged longitudinal sectional view illustrating, enlarged, a front-side portion and a rear-side portion while omitting an intermediate portion of a mechanical pencil according to a second embodiment; and

FIG. 3 is a partially-enlarged longitudinal sectional view illustrating, enlarged, a front-side portion and a rear-side portion while omitting an intermediate portion of a mechanical pencil according to a third embodiment.

### DESCRIPTION OF EMBODIMENTS

### First Embodiment

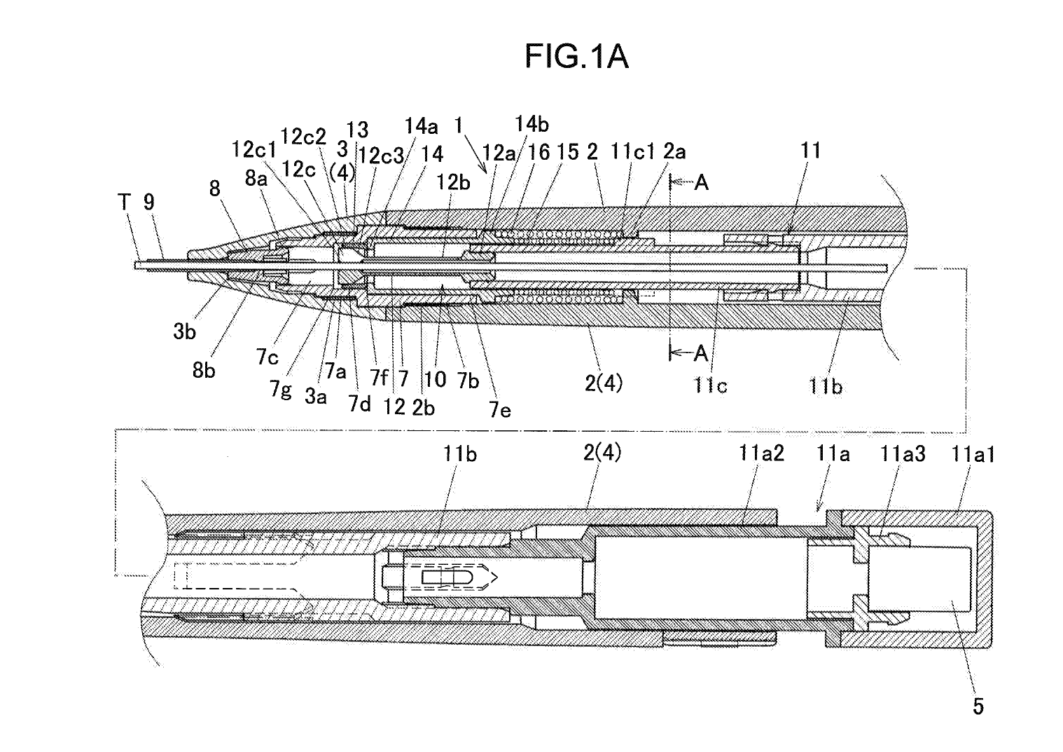

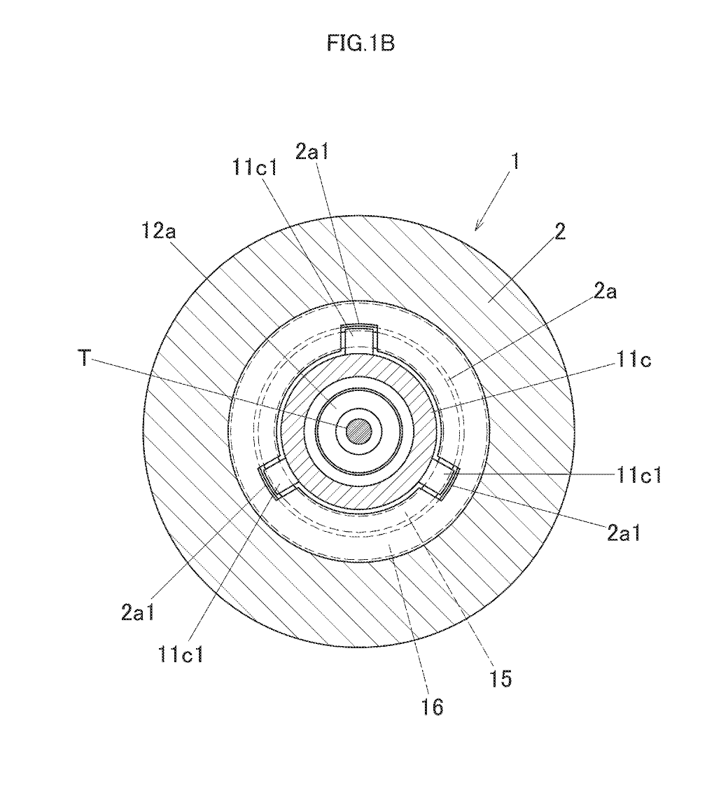

Hereinafter, a first embodiment will be described with reference to FIGS. 1A and 1B. A mechanical pencil 1 is a rear end push-type mechanical pencil in which a writing lead for a mechanical pencil T is fed out and protruded from a tip of a tip fitting 3 by a push operation on a push cap 11a1 of a push button 11a. Moreover, in the following description, a side on which the tip fitting 3 of the mechanical pencil 1 is arranged will be referred to as front in a direction of a central axis (an axial direction) and a side on which the push button 11a is arranged will be referred to as rear.

The mechanical pencil 1 includes a barrel main body 2 with an approximately cylindrical shape and the tip fitting 3 with an approximately conical shape. The barrel main body 2 and the tip fitting 3 arranged to the front of the barrel main body 2 are screwed and fastened via a connection tube 7 as will be described in detail later. The push button 11a is attachably and detachably mounted to a rear end of the barrel main body 2. The push button 11a includes a push button main body 11a2 that attachably and detachably fits with a lead tube 11b to be described later. An eraser ferrule 11a3 is fixed to a rear part of the push button main body 11a2 that is formed in an approximately cylindrical shape. A through hole is formed through the eraser ferrule 11a3 along a central axis thereof. The writing lead for a mechanical pencil T can be replenished to the mechanical pencil 1 through the through hole of the eraser ferrule 11a3 and an inside of the push button main body 11a2 formed in an approximately cylindrical shape. An eraser 5 is attachably and detachably mounted to a rear end of the eraser ferrule 11a3. A push cap 11a1 that covers the eraser 5 is attachably and detachably mounted to an outer circumference of a rear end of the push button 11a.

A writing lead tube 11b with an approximately cylindrical shape to which the push button 11a is attachably and detachably fitted is arranged to the front of the push button 11a. A front part of the lead tube 11b is assembled to an approximately cylindrical shaped chuck joint 11c that is arranged further to the front of the writing lead tube 11b. The writing lead for a mechanical pencil T can be supplied further forward through insides of the writing lead tube 11b and the chuck joint 11c that are respectively formed in approximately cylindrical shapes. The push button 11a, the writing lead tube 11b, and the chuck joint 11c constitute a writing lead housing 11.

An annular projection 2a that annularly protrudes inward in a radial direction from an inner circumferential surface of the barrel main body 2 is formed on a front side of the barrel main body 2. The annular projection 2a has a first level difference (step) including an engaging surface facing the front in the axial direction as will be described in detail later. Meanwhile, three flanges 11c1 that protrude outward in the radial direction are formed on an outer circumferential surface of the chuck joint 11c. As illustrated in FIG. 1B, the flanges 11c1 of the chuck joint 11c are formed as three projections arranged at 120-degree intervals in a circumferential direction. In addition, three through grooves 2a1 which the flanges 11c1 of the chuck joint 11c can pass through in the axial direction are formed on the annular projection 2a of the barrel main body 2 at 120-degree intervals in the circumferential direction as illustrated in FIG. 1B. The flanges 11c1 of the chuck joint 11c as well as the through grooves 2a1 and the first level difference of the annular projection 2a of the barrel main body 2 will be described in detail later.

A chuck 12 is fixed to a tip of the chuck joint 11c. The chuck 12 is formed divided into three parts around the central axis so as to be capable of chucking the writing lead for a mechanical pencil T by clamping in a radial direction. The chuck 12 has a rear end base part 12a fixed to the chuck joint 11c, a beam-like part 12b extending forward from the base part 12a, and a bulging part 12c formed at a front end of the beam-like part 12b. The bulging part 12c further has a front end surface part 12c1, a maximum outer circumferential surface part 12c2, and an inclined part 12c3. The front end surface part 12c1 is formed and configured to be a surface approximately orthogonal to the central axis when the chuck 12 chucks the writing lead for a mechanical pencil T. The maximum outer circumferential surface part 12c2 is formed as an outer circumferential surface approximately parallel to the central axis in a side view and is connected to the front end surface part 12c1. The inclined part 12c3 extends rearward as an inclined surface which is connected to the maximum outer circumferential surface part 12c2 and of which an outer diameter decreases rearward. The inclined part 12c3 is connected at a rear end thereof to the beam-like part 12b.

A chuck ring 13 is fitted to an outer circumference of the bulging part 12c of the chuck 12. The chuck ring 13 is formed in an approximately tubular shape having, at a rear end thereof, an annular wall extending in an inner diameter direction, and attachably and detachably fits from the rear to the maximum outer circumferential surface part 12c2 of the bulging part 12c. As the chuck ring 13 is fitted to or detached from the bulging part 12c, the chuck 12 and the chuck ring 13 chuck or release the writing lead for a mechanical pencil T. More specifically, the chuck 12 is formed such that, when the chuck ring 13 is not fitted to the bulging part 12c, each of the trisected tip of the chuck 12 opens in an outer diameter direction due to elasticity of the beam-like part 12b to release the writing lead for a mechanical pencil T. On the other hand, when the tip of the chuck ring 13 slides on the inclined part 12c3 of the chuck 12, fits to the bulging part 12c of the chuck 12, and closes the chuck 12, the chuck 12 and the chuck ring 13 clamp and chuck the writing lead for a mechanical pencil T inward in the radial direction.

A sleeve 14 formed in an approximately tubular shape is arranged at an outer circumference of a tip portion of the chuck joint 11c and the base part 12a and the beam-like part 12b of the chuck 12. An annular wall part 14a annularly protruding in an inner diameter direction is formed at a front end of the sleeve 14. In addition, an annular projection 14b annularly protruding in an outer diameter direction is formed on an outer circumferential surface on a rear side of the sleeve 14. A chuck spring 15 that is a coil spring is arranged compressed in the axial direction between a rear end surface of the sleeve 14 and a front surface of the flange 11c1 of the chuck joint 11c on an outer circumference on a front side of the chuck joint 11c. Therefore, the chuck 12 and the writing lead housing 11 are biased rearward by the chuck spring 15 with respect to the sleeve 14. The chuck 12 and the writing lead housing 11 push the chuck ring 13 toward a front surface of the annular wall part 14a of the sleeve 14 and, accordingly, the chuck 12 and the chuck ring 13 fit to each other and chuck the writing lead for a mechanical pencil T.

A cushion spring 16 that is a coil spring is arranged with a compressed state in the axial direction between a rear surface of the annular projection 14b of the sleeve 14 and a front surface of the annular projection 2a of the barrel main body 2. The sleeve 14 and the cushion spring 16 elastically support the chucking/feed-out mechanism 10 of the mechanical pencil 1 in the axial direction. Therefore, when prescribed writing pressure in the axial direction is applied to the writing lead for a mechanical pencil T, since the chucking/feed-out mechanism 10 chucking the writing lead for a mechanical pencil T can recede rearward and reduce compression of the writing lead for a mechanical pencil T, breakage of the writing lead for a mechanical pencil T can be prevented.

A connection tube 7 which connects the barrel main body 2 with the tip fitting 3 is arranged on an outer side in the radial direction of a front part of the sleeve 14 to the front of the sleeve 14. External screw parts 7a and 7b are formed on an outer circumferential surface of the connection tube 7. The front-side external screw part 7a screws with an internal screw part 3a formed on an inner circumferential surface of a rear part of the tip fitting 3. The rear-side external screw part 7b screws with an internal screw part 2b formed on an inner circumferential surface of a front part of the barrel main body 2. The barrel main body 2 and the tip fitting 3 are connected to each other via the connection tube 7 to configure a barrel 4. The connection tube 7 includes a tip slider housing 7c which is arranged to the front of the connection tube 7 and which houses the tip slider 8, a chuck ring housing 7d which has an inner space with a larger diameter than the tip slider housing 7c and which is arranged to the rear of the tip slider housing 7c, and a sleeve housing 7e which has an inner space with an even larger diameter than the chuck ring housing 7d and which is arranged to the rear of the chuck ring housing 7d.

A step part 7f which abuts against a front end surface of the sleeve 14 (the annular wall part 14a) in the axial direction is formed in a connecting part of the sleeve housing 7e and the chuck ring housing 7d. The step part 7f of the connection tube 7 receives a biasing force of the cushion spring 16 which biases the sleeve 14 forward, and restricts further forward movement of the sleeve 14. A step part 7g abutted by a front end of the chuck ring 13 having moved forward is formed in a connecting part of the chuck ring housing 7d and the tip slider housing 7c. A prescribed interval is provided between a front end of the receded chuck ring 13 and the step part 7g to allow forward movement of the chuck ring 13. As the front end of the chuck ring 13 abuts against the step part 7g after moving forward by the prescribed interval and the chuck ring 13 moves rearward relative to the chuck 12, the chuck ring 13 detaches from the chuck 12. The chuck 12 moves further forward inside the tip slider housing 7c and releases the writing lead for a mechanical pencil T and, accordingly, the writing lead for a mechanical pencil T is fed out by a prescribed feed-out amount per one push operation of the mechanical pencil 1. Subsequently, when the chucking/feed-out mechanism 10 of the mechanical pencil 1 is released from the push operation, the chuck 12 and the chuck ring 13 recede without the fed-out writing lead for a mechanical pencil T, and once again chuck a more rearward position of the writing lead for a mechanical pencil T.

The receded tip slider 8 can be housed inside the tip slider housing 7c. A writing lead guide 9 is fixed to a tip part of the tip slider 8. An annular engaging part 8a protruding in the outer diameter direction is formed on an outer circumferential surface of a rear end part of the tip slider 8. The engaging part 8a of the tip slider 8 engages with an engaging part which protrudes in an inner diameter direction and which is formed on an inner circumferential surface of a tip part of the tip slider housing 7c of the connection tube 7, and imparts a prescribed engaging force against a movement in the axial direction of the tip slider 8 to the tip slider 8. Therefore, for example, when drawing a line by placing a ruler against the writing lead guide 9, since the writing lead guide 9 is supported by a prescribed engaging force in the axial direction by the tip slider 8 even when a rearward force in the axial direction acts on the writing lead guide 9, the writing lead guide 9 does not recede. On the other hand, when a rearward load in the axial direction exceeding the prescribed engaging force created due to the engagement of the connection tube 7 and the tip slider 8 is applied to the writing lead guide 9, since the engagement of the connection tube 7 and the tip slider 8 is released, the writing lead guide 9 can be retracted inside the tip slider housing 7c. In addition, an outer circumferential surface of the engaging part 8a of the tip slider 8 is configured to come into contact with and slide on an inner circumferential surface of the tip slider housing 7c of the connection tube 7. Therefore, unless the tip slider 8 is pushed by the chuck 12 and once again moves forward due to a push operation of the chucking/feed-out mechanism 10 as will be described in detail later, the writing lead guide 9 can be prevented from unintentionally protruding from the tip fitting 3. Since the writing lead guide 9 can be retracted inside the barrel 4 in this manner, for example, even when the mechanical pencil 1 is carried around inside a pocket of clothing, breakage of the writing lead guide 9 due to bending or the like does not occur.

The tip slider 8 further has a chucking breaker part 8b formed as an annular projection that protrudes in an inner diameter direction. By clamping the writing lead for a mechanical pencil T in the radial direction, since the chucking breaker part 8b applies a prescribed resisting force against movement of the writing lead for a mechanical pencil T in the axial direction, the writing lead for a mechanical pencil T can be prevented from unintentionally moving in the axial direction when the writing lead for a mechanical pencil T is not chucked by the chuck 12. The chucking/feed-out mechanism 10 which chucks and feeds out the writing lead for a mechanical pencil T according to the present embodiment includes the writing lead housing 11, the chuck 12, the chuck ring 13, the sleeve 14, the chuck spring 15, and the cushion spring 16. As in the case of the writing lead housing 11 according to the present embodiment, a part of the writing lead housing 11 (specifically, a part of the push button 11a) protrudes rearward from the barrel main body 2 in the plurality of embodiments of the present invention, and even in such cases, the chucking/feed-out mechanism 10 is considered/deemed to be substantially housed in the barrel 4.

An actuation of the chucking/feed-out mechanism 10 when a push operation is performed on the mechanical pencil 1 in which the tip slider 8 is housed inside the barrel 4 will be described. When a forward push operation of the push button 11a is performed against a resilient force of the chuck spring 15 and the writing lead housing 11 is moved forward, the chuck 12 fixed to the writing lead housing 11 moves forward while chucking the writing lead for a mechanical pencil T. When the step part 7g of the connection tube 7 abuts against the front end of the chuck ring 13, the chuck ring 13 detaches rearward from the bulging part 12c of the chuck 12 and the writing lead for a mechanical pencil T is released at a position where the writing lead for a mechanical pencil T is fed out forward. At this point, the rear end of the tip slider 8 is pushed by the front end of the chuck 12 and moves forward, a state is created where the writing lead guide 9 protrudes from the tip of the tip fitting 3, and a tip part of the connection tube 7 engages with the rear end part of the tip slider 8. When pushing (push operation) of the push button 11a is released, the chuck 12 and the writing lead housing 11 recede due to the resilient force of the chuck spring 15. At this point, due to the chucking breaker part 8b of the tip slider 8 having engaged with the connection tube 7, since the writing lead for a mechanical pencil T is grasped at a position where the writing lead for a mechanical pencil T is fed out forward, the released writing lead for a mechanical pencil T does not recede. Furthermore, when the chuck 12 and the writing lead housing 11 recede, the chuck ring 13 is fitted to the bulging part 12c of the chuck 12, a state prior to the push operation where the rear surface of the chuck ring 13 abuts against the front surface of the annular wall part 14a of the sleeve 14 is restored, and the writing lead for a mechanical pencil T is once again chucked by the chuck 12 at a position further toward the rear than the position prior to the push operation.

Since the writing lead for a mechanical pencil T can be sequentially fed out forward by repetitively performing push operations of the push button 11a, the writing lead for a mechanical pencil T protrudes from the tip of the writing lead guide 9 and writing can be performed using the mechanical pencil 1. Writing pressure applied when writing with the mechanical pencil 1 is transmitted to the sleeve 14 abutting against the chuck ring 13 via the chuck 12 that chucks the writing lead for a mechanical pencil T and the chuck ring 13 fitted to the chuck 12. In addition, the writing pressure applied when writing with the mechanical pencil 1 is supported in the axial direction by the annular projection 2a of the barrel main body 2 via the cushion spring 16 that elastically supports the sleeve 14.

When the writing lead for a mechanical pencil T is subjected to prescribed writing pressure exceeding a mounting (set) load of the cushion spring 16, the cushion spring 16 is compressed and the chucking/feed-out mechanism 10 of the mechanical pencil 1 recedes. In the mechanical pencil 1 according to the present embodiment, as illustrated in FIG. 1B, the flanges 11c1 of the chuck joint 11c are configured so as to be capable of receding by passing through the through grooves 2a1 of the annular projection 2a of the barrel main body 2. After the flanges 11c1 recede by passing through the through grooves 2a1, the rear end of the chuck spring 15 is supported in the axial direction by the annular projection 2a of the barrel main body 2 in place of the flanges 11c1.

When the rear end of the chuck spring 15 is supported by the annular projection 2a of the barrel main body 2, a part of a biasing force of the chuck spring 15 which biases the chuck 12 rearward with respect to the sleeve 14 and a force by which the annular projection 2a of the barrel main body 2 supports the chuck spring 15 forward cancel each other out. In other words, the biasing force by which the chuck spring 15 biases the chuck 12 rearward (an output of the chuck spring 15 with respect to the chuck 12) so as to chuck the writing lead for a mechanical pencil T is reduced. At this point, a second level difference (step) of the chucking/feed-out mechanism 10 including a rear end surface (an engaging surface) of the chuck spring 15 engages in the axial direction with the first level difference (step) included in the annular projection 2a of the barrel main body 2. The force by which the annular projection 2a of the barrel main body 2 supports the chuck spring 15 forward is provided by writing pressure applied to the barrel main body 2. Accordingly, output of the chuck spring 15 with respect to the chucking/feed-out mechanism 10 is reduced and the chuck on the writing lead for a mechanical pencil T by the chuck 12 and the chuck ring 13 is relaxed.

Once the chuck on the writing lead for a mechanical pencil T by the chuck 12 and the chuck ring 13 is relaxed, a writing lead holding force on the writing lead for a mechanical pencil T by the mechanical pencil 1 declines and the writing lead for a mechanical pencil T can recede rearward in the axial direction. At this point, since the chuck on the writing lead for a mechanical pencil T by the chuck 12 and the chuck ring 13 is at least more relaxed than usual, damage to the outer circumferential surface of the writing lead for a mechanical pencil T can be prevented as compared to a case where a writing lead slippage occurs when the writing lead for a mechanical pencil T is normally chucked as is conventional. Therefore, a decline in the writing lead holding force of the writing lead for a mechanical pencil T by the mechanical pencil 1 can be prevented when subsequently using the mechanical pencil 1 by once again feeding out the writing lead for a mechanical pencil T. In addition, since the writing lead guide 9 is also configured so as to be retractable inside the tip fitting 3 as described earlier, when a prescribed load in the axial direction is applied to the writing lead for a mechanical pencil T of the mechanical pencil 1 according to the present embodiment, the writing lead guide 9 and the writing lead for a mechanical pencil T can both be retracted inside the mechanical pencil 1. With the mechanical pencil 1 according to the present embodiment, when a prescribed load in the axial direction is unintentionally applied to the writing lead for a mechanical pencil T, damage to the writing lead guide 9 and the writing lead for a mechanical pencil T can be prevented.

Furthermore, when a prescribed load in the axial direction is intentionally applied to the writing lead for a mechanical pencil T, the writing lead guide 9 and the writing lead for a mechanical pencil T can be readily retracted inside the mechanical pencil 1 without having to perform a push operation. In this case, the prescribed load can be set to, for example, a load which causes the cushion spring 16 to be compressed in the axial direction by a prescribed distance or a load smaller than a load which causes writing lead slippage of the writing lead for a mechanical pencil T chucked by the mechanical pencil 1.

### Second Embodiment

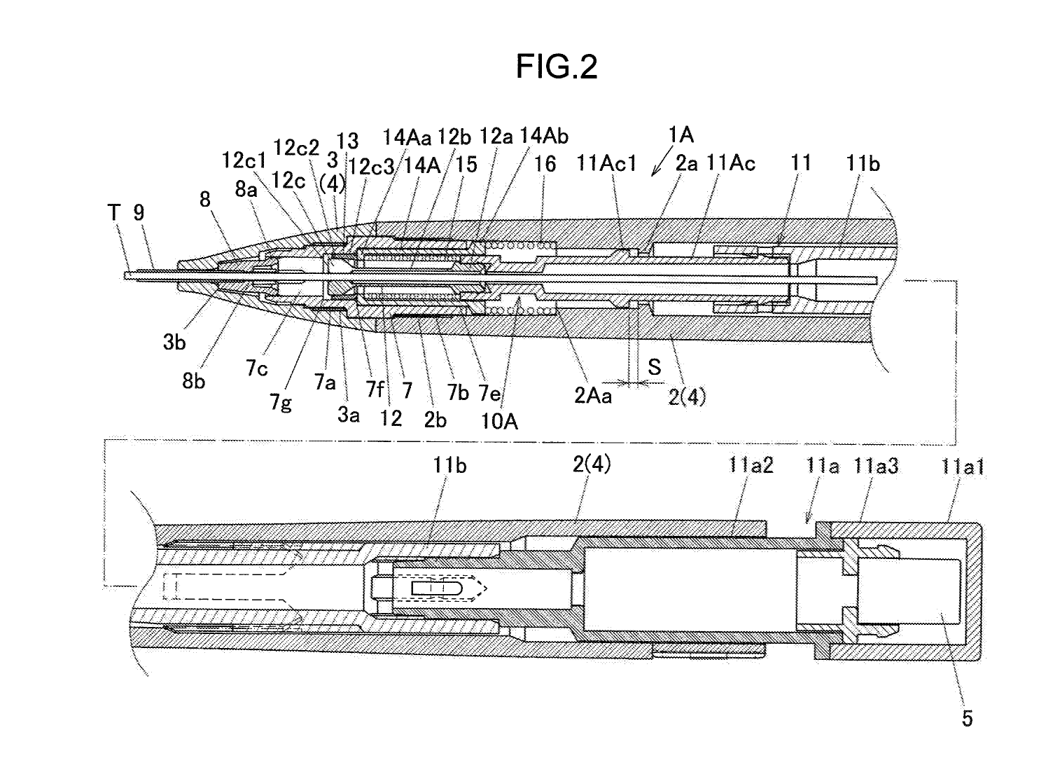

Next, a mechanical pencil 1A according to a second embodiment will be described with reference to FIG. 2. In the present embodiment, changes have been made to the shapes of the sleeve 14 and the chuck joint 11c and the arrangement of the chuck spring 15 according to the first embodiment. Note that same members and locations as the first embodiment are denoted by same reference signs and descriptions thereof will be either omitted or simplified.

A sleeve 14A according to the present embodiment is formed in an approximately tubular shape, has an annular wall part 14Aa formed at a front end thereof, and has an annular projection 14Ab annularly protruding in an outer diameter direction formed on an outer circumferential surface of a rear end thereof. The chuck spring 15 is arranged with a compressed state in an outer circumference of the chuck 12 (the beam-like part 12b) inside the sleeve 14A. The front end of the chuck spring 15 abuts against and is supported by a rear surface of the annular wall part 14Aa. The rear end of the chuck spring 15 abuts against and is supported by a front end surface of a chuck joint 11Ac. In a similar manner to the first embodiment, rearward relative movement of the chuck 12 and the writing lead housing 11 with respect to the sleeve 14A is restricted by the abutting of the rear surface of the chuck ring 13 against a front surface of the annular wall part 14Aa.

An annular projection 11Ac1 of the chuck joint 11Ac having a second level difference (step) opposing, in the axial direction, the first level difference (step) of the annular projection 2a of the barrel main body 2 is formed protruding in an outer diameter direction on an outer circumferential surface of the chuck joint 11Ac. The first level difference of the annular projection 2a of the barrel main body 2 and the second level difference of the annular projection 11Ac1 of the chuck joint 11Ac in the present embodiment are separated from each other in the axial direction and define a prescribed receding stroke S (a receding margin S) of the writing lead housing 11, the chuck 12, the chuck ring 13, and the sleeve 14A.

Even in the present embodiment, the writing lead for a mechanical pencil T can be fed out by a push operation on the push button 11a in a similar manner to the first embodiment. When a prescribed load in the axial direction is applied to the writing lead for a mechanical pencil T during use of the mechanical pencil 1A according to the present embodiment, the chuck 12, the chuck ring 13, the sleeve 14A, and the chuck joint 11Ac recede by the receding stroke S against the elastic supporting force of the cushion spring 16. When a chucking/feed-out mechanism 10A moves rearward by the receding stroke S, the second level difference including a rear surface (an engaging surface) of the annular projection 11Ac1 of the chuck joint 11Ac abuts from the front and engages with the first level difference including the front surface (the engaging surface) of the annular projection 2a of the barrel main body 2.

When the first level difference and the second level difference engage with each other in the axial direction, writing pressure applied forward in the axial direction from the barrel main body 2 via the first level difference and the second level difference and a biasing force by which the chuck spring 15 biases the chuck 12 rearward in the axial direction cancel each other out, and the biasing force of the chuck spring 15 is reduced. The biasing force by which the chuck spring 15 according to the present embodiment biases the chuck 12 rearward in the axial direction is an output of the chuck spring 15 with respect to the chuck 12 or, in other words, an output of the chuck spring 15 with respect to the chucking/feed-out mechanism 10A. The chucking/feed-out mechanism 10A chucks the writing lead for a mechanical pencil T due to the output of the chuck spring 15.

When the output of the chuck spring 15 with respect to the chuck 12 is reduced, the chuck on the writing lead for a mechanical pencil T by the chuck 12 and the chuck ring 13 is relaxed. Therefore, the writing lead for a mechanical pencil T subjected to a prescribed load in the axial direction can be retracted inside the tip fitting 3 together with the tip slider 8 and the writing lead guide 9 without breaking. As a result, in a similar manner to the first embodiment, breakage of the writing lead guide 9 and the writing lead for a mechanical pencil T can be prevented and the writing lead guide 9 and the writing lead for a mechanical pencil T can be readily retracted inside the tip fitting 3 without having to perform a push operation.

### Third Embodiment

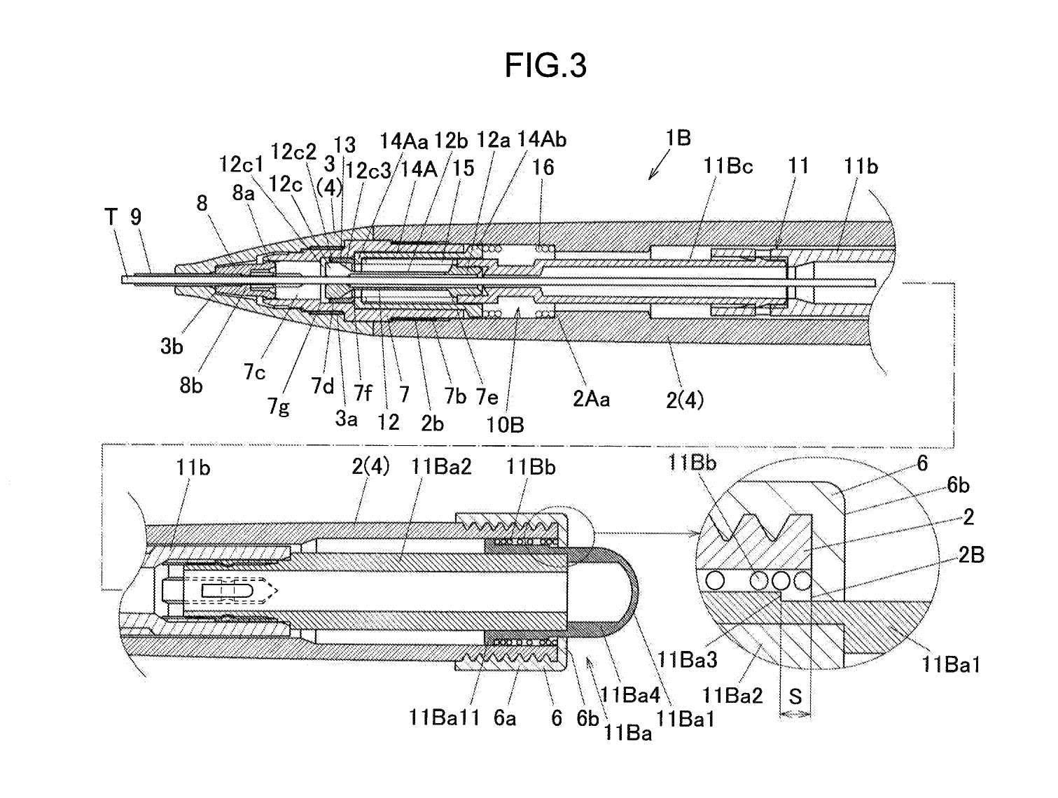

Next, a third embodiment will be described with reference to FIG. 3. In the present embodiment, a mechanical pencil 1B will be described in which the first level difference (step) and the second level difference (step) of the mechanical pencil 1A according to the second embodiment have been changed so as to be arranged in the rear end part of the mechanical pencil. Therefore, in the following description, same members and locations as the first and second embodiments presented above are denoted by same reference signs and descriptions thereof will be either omitted or simplified.

The mechanical pencil 1B according to the present embodiment does not include the annular projection 2a of the barrel main body 2 and the annular projection 11Ac1 of the chuck joint 11Ac according to the second embodiment. On the other hand, the barrel main body 2 has a rear end cover 6 to be mounted to the rear end thereof. The rear end cover 6 has a rear end cover main body 6a with an approximately tubular shape and an annular wall part 6b protruding inward in the radial direction and formed at a rear end of the rear end cover main body 6a. The annular wall part 6b of the rear end cover 6 corresponds to the annular projection 2a of the barrel main body 2 according to the second embodiment and has a first level difference including a front surface 2B which faces the axial direction. A pair of screws is formed on each of an inner circumferential surface of the rear end cover main body 6a and the outer circumferential surface of the rear end of the barrel main body 2, and the barrel main body 2 and the rear end cover 6 are attachably and detachably fastened to each other. In this manner, a portion corresponding to the annular projection 2a of the barrel main body 2 according to the second embodiment may be formed as a separate body to the barrel main body 2 to be assembled to the barrel main body 2.

A push button 11Ba is fitted and assembled from the rear to the rear end of the writing lead tube lib. The push button 11Ba according to the present embodiment has a push cap 11Ba1 and a push button main body 11Ba2. The push cap 11Ba1 further has a plurality of abutting projections 11Ba4 projecting inward in a radial direction of the push cap 11Ba1. The push cap 11Ba1 is attachably and detachably assembled to a rear end of the push button main body 11Ba2 in a state where front ends of the plurality of abutting projections 11Ba4 abut against the rear end of the pushbutton main body 11Ba2. A rear end of the push cap 11Ba1 protrudes rearward from the annular wall part 6b of the rear end cover 6. A flange part 11Ba11 protruding outward in the radial direction of the push cap 11Ba1 is formed at a front end of the push cap 11Ba1. A push spring 11Bb is arranged with a compressed state in the axial direction between a rear surface of the flange part 11Ba11 and a front surface of the annular wall part 6b of the rear end cover 6.

A large diameter part having a second level difference is formed on an outer circumferential surface of the push cap 11Ba1, and a rear surface (an abutting surface) 11Ba3 of the second level difference opposes the front surface (an abutting surface) 2B of the first level difference in the axial direction. The push cap 11Ba1 is elastically supported forward in the axial direction by the push spring 11Bb, and the front surface 2B of the first level difference of the rear end cover 6 and the rear surface 11Ba3 of the second level difference of the push cap 11Ba1 are arranged so as to have a prescribed receding stroke S in the axial direction.

Even in the present embodiment, the writing lead for a mechanical pencil T can be fed out by a push operation on the push button 11Ba in a similar manner to the first and second embodiments. When a prescribed load in the axial direction is applied to the writing lead for a mechanical pencil T during use of the mechanical pencil 1B according to the present embodiment, the chuck 12, the chuck ring 13, the sleeve 14A, and the chuck joint 11Bc recede by the receding stroke S against the elastic supporting force of the cushion spring 16 and the push spring 11Bb. When the chucking/feed-out mechanism 10B moves rearward by the receding stroke S, the front surface 2B of the first level difference of the rear end cover 6 and the rear surface 11Ba3 of the second level difference of the push cap 11Ba1 abut and engage with each other in the axial direction.

When the front surface 2B of the first level difference and the rear surface 11Ba3 of the second level difference engage with each other in the axial direction, writing pressure applied forward in the axial direction from the barrel main body 2 via the first level difference and the second level difference and a biasing force by which the chuck spring 15 biases the chuck 12 rearward in the axial direction cancel each other out, and the biasing force of the chuck spring 15 is reduced. The biasing force by which the chuck spring 15 according to the present embodiment biases the chuck 12 rearward in the axial direction is an output of the chuck spring 15 with respect to the chuck 12 or, in other words, an output of the chuck spring 15 with respect to the chucking/feed-out mechanism 10B. The chucking/feed-out mechanism 10B chucks the writing lead for a mechanical pencil T due to the output of the chuck spring 15.

When the output of the chuck spring 15 with respect to the chuck 12 is reduced, the chuck on the writing lead for a mechanical pencil T by the chuck 12 and the chuck ring 13 is relaxed. Therefore, the writing lead for a mechanical pencil T subjected to a prescribed load in the axial direction can be retracted inside the tip fitting 3 together with the tip slider 8 and the writing lead guide 9 without breaking. As a result, in a similar manner to the first and second embodiments, breakage of the writing lead guide 9 and the writing lead for a mechanical pencil T can be prevented and the writing lead guide 9 and the writing lead for a mechanical pencil T can be readily retracted inside the tip fitting 3 without having to perform a push operation. Moreover, while the mechanical pencil 1B has been described in the present embodiment as including the sleeve 14 and the cushion spring 16, in other embodiments, the sleeve 14 and the cushion spring 16 need not be provided and a cushion mechanism solely constituted by the push cap 11Ba1 and the push spring 11Bb may be configured. In this case, the chuck spring 15 may be configured to bias the chuck 12 rearward in the axial direction with respect to the chuck ring 13. In this case, an actuation similar to those of the mechanical pencil 1B described above can be realized with an even simpler configuration.

While a plurality of embodiments have been described above, it is to be understood that the present invention is not limited to the described embodiments and can be implemented in in a wide variety of modes. For example, it has been described that the annular projection 2a (the first and second embodiments) and the annular wall part 6b (the third embodiment) each including the first level difference are formed so as to project inward in the radial direction from the inner circumferential surface of the barrel main body 2 and that the rear end of the chuck spring 15 (the first embodiment), the annular projection 11Ac1 (the second embodiment), and the large diameter part of the push button (the third embodiment) each including the second level difference are formed so as to project outward in the radial direction from the respective outer circumferential surfaces of the chucking/feed-out mechanisms 10, 10A, and 10B. However, these configurations are not restrictive and, for example, one of the first and second level differences may be formed in a recessed shape having a first engaging surface in the axial direction in a longitudinal sectional view and the other of the first and second level differences may be formed in a protruded shape or a recessed shape having a second engaging surface in the axial direction in the longitudinal sectional view so as to be capable of engaging with each other. The first and second level differences are preferably configured to be opposed each other so as to be capable of engaging with each other in the axial direction. In addition, as long as engagement in the axial direction can be achieved, the first and second engaging surfaces may have arbitrary angles of inclination. Furthermore, besides forming one each of the first level difference and the second level difference and combining the two level differences, the first level difference and the second level difference may be respectively formed in plurality and a mechanical pencil may be configured by combining the plurality of level differences.

In addition, while it has been described that the chuck spring 15 biases the chuck 12 rearward in the axial direction with respect to the sleeve 14, a direction of output of a chuck spring configured to chuck a writing lead for a mechanical pencil with respect to a chucking/feed-out mechanism is not limited to rearward in the axial direction. In yet another embodiment, a mechanical pencil may include an arbitrary chucking/feed-out mechanism configured such that a chuck on a writing lead for a mechanical pencil is relaxed when an output of a chuck spring with respect to the chucking/feed-out mechanism in an arbitrary direction of output is canceled out by writing pressure applied to a barrel. Furthermore, a push button is not limited to being arranged at a rear end and a push mechanism actuated by a sideways push, a sideways slide, or a rotating operation may be adopted. Moreover, the load applied to a writing lead for a mechanical pencil in the axial direction may be a static load or a shock load. For example, when a mechanical pencil is inadvertently dropped in a state where a writing lead for a mechanical pencil is pointing downward, since inertia of the fall of the mechanical pencil acts on a barrel in place of the writing pressure that has been described to be applied to the barrel in the embodiments presented above, a similar actuation of the mechanical pencil to those in the embodiments presented above can be obtained.

What is claimed is:

1. A mechanical pencil, comprising:
a barrel; and
a chucking/feed-out mechanism chucking and feeding out a writing lead for a mechanical pencil, the chucking/feed-out mechanism configured to include a chuck, a chuck ring, and a chuck spring and being substantially housed in the barrel, wherein
the barrel has a first level difference on an inner circumferential surface thereof,
the chucking/feed-out mechanism has a second level difference opposing the first level difference, and
when a prescribed load in an axial direction is applied to the writing lead for a mechanical pencil, the first level difference and the second level difference engage with each other in the axial direction to reduce an output of the chuck spring with respect to the chucking/feed-out mechanism and relax the chuck on the writing lead for a mechanical pencil by the chuck and the chuck ring.

2. The mechanical pencil according to claim 1, wherein the second level difference is configured to include a rear end surface of the chuck spring.

3. The mechanical pencil according to claim 1, wherein the chucking/feed-out mechanism further includes a sleeve that houses the chuck spring, a cushion spring that biases the sleeve forward relative to the barrel, and a receding margin that enables the sleeve to recede when a prescribed load in the axial direction is applied to the writing lead for a mechanical pencil.

4. The mechanical pencil according to claim 1, wherein the chucking/feed-out mechanism further includes a push button, and the second level difference is formed on the push button.
